(19) United States
(12) Patent Application Publication
(10) Pub. No.: US 2026/0221564 A1
(43) Pub. Date: Jul. 30, 2026

(54) INSULATION MEMBER FOR ELECTROCHEMICAL DEVICE

(71) Applicant: DAIKIN INDUSTRIES, LTD., Osaka (JP)

(72) Inventors: Takahisa AOYAMA, Osaka (JP); Tomihiko Yanagiguchi, Osaka (JP); Hayato Tsuda, Osaka (JP); Taketo Kato, Osaka (JP)

(73) Assignee: DAIKIN INDUSTRIES, LTD., Osaka (JP)

(21) Appl. No.: 19/575,102

(22) Filed: Mar. 23, 2026

Related U.S. Application Data
(63) Continuation of application No. PCT/JP2024/034999, filed on Sep. 30, 2024.

(30) Foreign Application Priority Data
Sep. 29, 2023 (JP) 2023-169989

(51) Int. Cl. H01M 50/198; H01M 10/052; H01M 10/054; H01M 50/186; H01M 50/193

(52) U.S. Cl. CPC H01M 50/198; H01M 10/052; H01M 10/054; H01M 50/186; H01M 50/193

(57) ABSTRACT

An insulating member for an electrochemical device, capable of maintaining insulating properties even at high temperatures. An insulating member for an electrochemical device, containing a polytetrafluoroethylene composition containing polytetrafluoroethylene, the polytetrafluoroethylene including a tetrafluoroethylene homopolymer or a modified polytetrafluoroethylene containing a tetrafluoroethylene unit and 1.0% by mass or less of a modifying monomer unit.

### CROSS REFERENCE TO RELATED APPLICATIONS

This application is a Rule 53(b) Continuation of International Application No. PCT/JP2024/034999 filed Sep. 30, 2024, claiming priority based on Japanese Application No. 2023-169989 filed Sep. 29, 2023, the respective disclosures of which are patent incorporated herein by reference in their entirety.

### TECHNICAL FIELD

The disclosure relates to insulating members for electrochemical devices.

### BACKGROUND ART

It is known that resins such as perfluoroalkoxy alkane (PFA) are used as insulating members or sealing members for electrochemical devices such as lithium-ion secondary batteries (see Patent Literatures 1 to 3, for example).

### CITATION LIST

### Patent Literature

Patent Literature 1: JP 2017-174732 A
Patent Literature 2: WO 2020/066050
Patent Literature 3: WO 2014/049645

### SUMMARY

The disclosure (1) relates to an insulating member for an electrochemical device, containing a polytetrafluoroethylene composition containing polytetrafluoroethylene, the polytetrafluoroethylene including a tetrafluoroethylene homopolymer or a modified polytetrafluoroethylene containing a tetrafluoroethylene unit and 1.0% by mass or less of a modifying monomer unit.

### Advantageous Effects

The disclosure can provide an insulating member for an electrochemical device, capable of maintaining insulating properties even at high temperatures.

### BRIEF DESCRIPTION OF DRAWINGS

FIG. 1 is a schematic cross-sectional view showing an example of the configuration of a portion that includes an insulating member (gasket) of an electrochemical device.

FIG. 2 is a schematic cross-sectional view showing an example of the configuration of a portion that includes an insulating member (gasket) of an electrochemical device.

FIG. 3 is a schematic cross-sectional view showing an example of the configuration of a portion that includes an insulating member (gasket) of an electrochemical device.

FIG. 4 schematically shows a procedure for preparing a test assembly used for insulation resistance measurement.

FIG. 5 schematically shows a procedure for preparing a test assembly used for insulation resistance measurement.

FIG. 6 is a schematic diagram of a test assembly used for insulation resistance measurement.

FIG. 7 schematically shows one step of insulation resistance measurement.

FIG. 8 is a schematic diagram of a transmission test jig used in a water vapor transmission test.

### DESCRIPTION OF EMBODIMENTS

The disclosure is described in detail below.

The disclosure provides an insulating member for an electrochemical device, containing a polytetrafluoroethylene (PTFE) composition containing PTFE, the PTFE including a tetrafluoroethylene (TFE) homopolymer or a modified PTFE containing a TFE unit and 1.0% by mass or less of a modifying monomer unit (hereafter, also referred to as insulating member (1) of the disclosure).

The insulating member (1) of the disclosure and the later-described insulating member (2) of the disclosure are herein collectively referred to as “insulating member of the disclosure”, unless otherwise stated.

The insulating member (1) of the disclosure containing a specific PTFE composition can maintain insulating properties even at high temperatures.

In electrochemical devices that require high output, such as lithium-ion batteries for power generation, a large number of cells are generally arranged in close proximity and connected in parallel or in series. In such a configuration, even if the temperature of the cell becomes abnormally high (for example, 400° C. or higher) due to an adjacent cell catching fire, the insulating member (1) of the disclosure can maintain good insulating properties and can prevent short circuits of the cell and short circuits between the components of the cell.

The PTFE in the insulating member (1) of the disclosure includes a TFE homopolymer or a modified PTFE. In order to achieve better insulating properties at high temperatures and excellent water vapor barrier properties, a modified PTFE is preferred.

The modified PTFE contains a TFE unit and 1.0% by mass or less of a modifying monomer unit. The amount of the TFE unit may be 99.0% by mass or more. The modified PTFE may consist of the TFE unit and the modifying monomer unit.

In order to further improve the insulating properties at high temperatures and the water vapor barrier properties, the amount of the modifying monomer unit in the modified PTFE is preferably within a range of 0.00001 to 1.0% by mass based on the total polymerized units. The lower limit of the amount of the modifying monomer unit is more preferably 0.0001% by mass, still more preferably 0.001% by mass, further preferably 0.005% by mass, even more preferably 0.010% by mass. The upper limit of the amount of the modifying monomer unit is preferably 0.90% by mass, more preferably 0.80% by mass, more preferably 0.50% by mass, still more preferably 0.40% by mass, further preferably 0.30% by mass, further preferably 0.20% by mass, particularly preferably 0.10% by mass.

The modifying monomer unit herein means a moiety that is part of the molecular structure of PTFE and is derived from a modifying monomer.

The amounts of the above polymerized units can be calculated by any appropriate combination of NMR, FT-IR, elemental analysis, and X-ray fluorescence analysis in accordance with the types of the monomers.

The modifying monomer may be any monomer copolymerizable with TFE. Examples thereof include a perfluoroolefin such as hexafluoropropylene (HFP); a hydrogen-containing fluoroolefin such as trifluoroethylene or vinylidene fluoride (VDF); a perhaloolefin such as chlorotrifluoroethylene (CTFE); a perfluorovinyl ether; a perfluoroallyl ether; a (perfluoroalkyl)ethylene; and ethylene. One modifying monomer may be used alone or two or more modifying monomers may be used in combination.

Examples of the perfluorovinyl ether include, but are not limited to, an unsaturated perfluoro compound represented by the following formula (A):

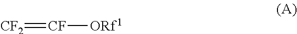

wherein Rf¹ is a perfluoro organic group. The term “perfluoro organic group” herein means an organic group in which all hydrogen atoms bonded to any carbon atom are replaced by fluorine atoms. The perfluoro organic group may have an ether oxygen.

Examples of the perfluorovinyl ether include a perfluoro (alkyl vinyl ether) (PAVE) represented by the formula (A) in which Rf¹ is a C1-C10 perfluoroalkyl group. The perfluoroalkyl group preferably has a carbon number of 1 to 5.

Examples of the perfluoroalkyl group in the PAVE include a perfluoromethyl group, a perfluoroethyl group, a perfluoropropyl group, a perfluorobutyl group, a perfluoropentyl group, and a perfluorohexyl group.

Examples of the perfluorovinyl ether also include:
those represented by the formula (A) wherein Rf¹ is a C4-C9 perfluoro (alkoxy alkyl) group;
those represented by the formula (A) wherein Rf¹ is a group represented by the following formula:

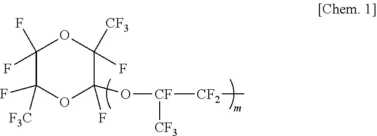

wherein m is an integer of 0 or 1 to 4; and
those represented by the formula (A) wherein Rf¹ is a group represented by the following formula:

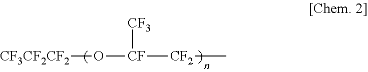

wherein n is an integer of 1 to 4.

Examples of the (perfluoroalkyl)ethylene (PFAE) include, but are not limited to, (perfluorobutyl)ethylene (PFBE) and (perfluorohexyl)ethylene.

Examples of the hydrogen-containing fluoroolefin include CH₂═CF₂, CFH═CH₂, CFH═CF₂, CH₂═CFCF₃, CH₂═CHCF₃, CHF═CHCF₃ (E-isomer), and CHF═CHCF₃ (Z-isomer).

Examples of the perfluoroallyl ether include fluoromonomers represented by the following formula (B):

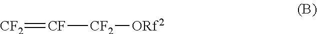

wherein Rf² is a perfluoro organic group.

Rf² is preferably a C1-C10 perfluoroalkyl group or a C1-C10 perfluoroalkoxyalkyl group. The perfluoroallyl ether preferably includes at least one selected from the group consisting of CF₂═CF—CF₂—O—CF₃, CF₂═CF—CF₂—O—C₂F₅, CF₂═CF—CF₂—O—C₃F₇, and CF₂═CF—CF₂—O—C₄F₉, more preferably includes at least one selected from the group consisting of CF₂═CF—CF₂—O—C₂F₅, CF₂═CF—CF₂—O—C₃F₇, and CF₂═CF—CF₂—O—C₄F₉, still more preferably CF₂═CF—CF₂—O—CF₂CF₂CF₃.

In order to further improve the insulating properties at high temperatures and the water vapor barrier properties, the modifying monomer preferably includes at least one selected from the group consisting of PAVE, PFAE, HFP, and CTFE, more preferably includes at least one selected from the group consisting of PAVE and HFP, still more preferably includes PAVE, further preferably includes perfluoro (propyl vinyl ether) (PPVE).

The PTFE may have a core-shell structure. An example of the PTFE having a core-shell structure is a modified PTFE including a core of high-molecular-weight PTFE and a shell of lower-molecular-weight PTFE or modified PTFE in a particle. Examples of this modified PTFE include PTFEs disclosed in JP 2005-527652 T.

The PTFE may be a PTFE obtained by emulsion polymerization or suspension polymerization. In order to improve the water vapor barrier properties, the PTFE is preferably a PTFE obtained by emulsion polymerization, more preferably an unsintered PTFE (having no history of being heated to a temperature equal to or higher than the melting point) obtained by emulsion polymerization.

In order to further improve the insulating properties at high temperatures, the endothermic peak temperature of the PTFE composition is preferably 333° C. or higher, more preferably 335° C. or higher, still more preferably 337° C. or higher, further preferably 340° C. or higher, while it is preferably 350° C. or lower, more preferably 346° C. or lower.

The endothermic peak temperature is the temperature corresponding to the minimum point on a heat-of-fusion curve obtained by performing differential scanning calorimetry (DSC) at a temperature-increasing rate of 10° C./min on a PTFE composition having no history of being heated to a temperature of 300° C. or higher. In the case where one melting peak includes two or more local minimums, each minimum is defined as an endothermic peak temperature.

In order to further improve the insulating properties at high temperatures, the melting point of the PTFE composition is preferably 315° C. or higher, more preferably 320° C. or higher, still more preferably 323° C. or higher, further preferably 325° C. or higher, while it is preferably 335° C. or lower, more preferably 330° C. or lower.

The melting point is the temperature corresponding to the minimum point on a heat-of-fusion curve obtained by performing differential scanning calorimetry (DSC) at a temperature-increasing rate of 10° C./min on a PTFE composition having a history of being heated to a temperature of 300° C. or higher.

The PTFE composition may be a PTFE composition that has not been fully sintered. A PTFE composition that has not been fully sintered has a large heat of fusion and may take a long time to completely melt, so it has an advantage that the temperature rise can be delayed when heat is generated, thereby preventing the temperature from becoming abnormally high in a short period of time.

In order to delay the temperature rise when heat is generated to prevent the temperature from becoming abnormally high in a short period of time, the heat of fusion of the PTFE composition is preferably 27 J/g or more, more preferably 30 J/g or more, still more preferably 33 J/g or more, particularly preferably 60 J/g or more, while it may be 90 J/g or less or 80 J/g or less.

The heat of fusion is a value measured using a differential scanning calorimeter (DSC).

In order to further improve the insulating properties at high temperatures, the heat of crystallization of the PTFE composition is preferably 50 J/g or less, more preferably 40 J/g or less, still more preferably 30 J/g or less, further preferably 25 J/g or less, while it may be 10 J/g or more or 15 J/g or more.

The heat of crystallization is a value measured using a differential scanning calorimeter (DSC).

In order to further improve the insulating properties at high temperatures, the thermal decomposition temperature of the PTFE composition is preferably 400° C. or higher, more preferably 430° C. or higher, still more preferably 450° C. or higher. It may be 600° C. or lower, 550° C. or lower, or 520° C. or lower.

The thermal decomposition temperature refers to a temperature at which the mass of the sample is reduced by 1% by mass in an air atmosphere at a temperature-increasing rate of 10° C./min using a simultaneous thermogravimetric analyzer (STA7200 available from Hitachi High-Tech Science Corp.).

In order to further improve the insulating properties at high temperatures, the melt viscosity at 380° C. of the PTFE composition is preferably 1.0×10⁷ Pa·s or more, more preferably 1.0×10⁸ Pa·s or more. It may be 1.0×10¹¹ Pa·s or less or 5.0×10¹⁰ Pa·s or less.

The melt viscosity is determined using a rheometer MCR 302 (available from Anton Paar Japan K.K.). The complex viscosity measured using a parallel plate with a diameter of 7 mm as a measurement jig, at a deformation rate of 0.3%, a sample thickness of 0.5 mm, a temperature of 380° C., and a frequency of 0.01 radians per second is taken as the melt viscosity.

In order to further improve the insulating properties at high temperatures, the standard specific gravity (SSG) of the PTFE composition is preferably 2.200 or less, more preferably 2.190 or less, still more preferably 2.180 or less, further preferably 2.175 or less, while it may be 2.130 or more, 2.140 or more, or 2.150 or more.

The SSG is determined by the water displacement method in conformity with ASTM D792 using a sample molded in conformity with ASTM D4895-89.

The PTFE composition preferably has non-melt secondary processibility. The non-melt secondary processibility refers to a property of a polymer with which the melt flow rate is not measurable at a temperature higher than the melting point in conformity with ASTM D1238 and D2116, in other words, a property with which the polymer does not easily flow even within a melting temperature range.

The PTFE composition preferably shows non-melt-moldability. The non-melt-moldability is described later.

The PTFE composition may be a sintered PTFE composition or an unsintered PTFE composition. The PTFE composition may be a PTFE composition having a history of being heated to a temperature equal to or higher than the melting point or a PTFE composition having no history of being heated to a temperature equal to or higher than the melting point.

A PTFE composition having no history of being heated to a temperature equal to or higher than the melting point becomes easily stretchable and soft when processed into a green tape. Such a PTFE composition tape when wrapped around a component readily conforms to the shape of the component. This allows easy adhesion of the PTFE composition tape not only to a component with a simple shape but also to a component with a complex shape, advantageously enabling, for example, provision of insulation to the area around the component.

The PTFE composition may contain a component other than the PTFE but preferably consists essentially of the PTFE. This allows remarkable exertion of the effect attributable to the PTFE. The phrase “consists essentially of the PTFE” means that the amount of the PTFE is 70% by mass or more based on the PTFE composition.

The amount of the PTFE is preferably 90.0% by mass or more, more preferably 95.0% by mass or more, still more preferably 99.0% by mass or more, particularly preferably 99.9% by mass or more, most preferably 99.95% by mass or more based on the PTFE composition.

The PTFE composition also preferably consists of the PTFE.

The PTFE composition may further contain a filler or the like. The filler is preferably an insulating filler, and is not preferably a conductive filler. Examples of the filler include known insulating fillers such as aluminum oxide, silicon oxide, magnesium oxide, anhydrous magnesium carbonate, magnesium hydroxide, silicon oxide, silicon nitride, boron nitride, and aluminum nitride, with magnesium oxide, aluminum nitride, and boron nitride being preferred.

The insulating member (1) of the disclosure may contain a component other than the PTFE composition but preferably consists essentially of the PTFE composition. This allows remarkable exertion of the effect attributable to the PTFE composition. The phrase “consists essentially of the PTFE composition” means that the amount of the PTFE composition is 70% by mass or more based on the insulating member.

The amount of the PTFE composition is preferably 90.0% by mass or more, more preferably 95.0% by mass or more, still more preferably 99.0% by mass or more, particularly preferably 99.9% by mass or more, most preferably 99.95% by mass or more based on the insulating member.

The insulating member (1) of the disclosure also preferably consists of the PTFE composition.

The insulating member (1) of the disclosure preferably exhibits non-melt-moldability. The non-melt-moldability is described later.

The insulating member (1) of the disclosure can be produced by molding a raw-material composition containing a raw-material PTFE into a desired shape. The raw-material composition may be in any form such as powder or a dispersion, and is preferably in the form of powder.

The raw-material PTFE can be produced by emulsion polymerization or suspension polymerization.

Emulsion polymerization can be performed by a known method. For example, an aqueous dispersion containing particles (primary particles) of the PTFE is obtainable by emulsion polymerization of monomers (TFE and optionally a modifying monomer) to form the PTFE in an aqueous medium in the presence of a fluorine-containing anionic surfactant and a polymerization initiator. In the emulsion polymerization, additives such as a chain transfer agent, a buffer, a pH adjuster, a stabilization aid, a dispersion stabilizer, and a radical scavenger may be used as appropriate.

The resulting aqueous dispersion is coagulated to obtain a wet powder, and the wet powder is dried, whereby a raw-material PTFE powder can be obtained. Coagulation and drying may be performed by any known techniques.

Suspension polymerization may be performed by, for example, charging a reactor with monomers such as TFE, an aqueous medium, and optionally other additives, stirring the contents in the reactor, maintaining the reactor at a predetermined polymerization temperature, and then adding a predetermined amount of a polymerization initiator to initiate the polymerization reaction. After the initiation of the polymerization reaction, the components such as the monomers including TFE, the polymerization initiator, and a chain transfer agent may additionally be added depending on the purpose.

The resulting suspension polymerized particles may be washed and then pulverized, or the resulting suspension polymerized particles may be pulverized while being washed, to produce pulverized particles.

The wet pulverized particles may be dehydrated to be further dried. Drying is performed for the purpose of removing moisture from the pulverized particles obtained through pulverization.

The pulverized particles obtained by pulverizing suspension polymerized particles may be classified by a known method such as air classification. The resulting pulverized particles may be granulated by a known granulation method.

Adjustment of the conditions during the polymerization or post treatment enables adjustment of physical properties of the resulting PTFE.

In emulsion polymerization, for example, the endothermic peak temperature can be increased, the standard specific gravity can be lowered, and the melt viscosity can be increased by reducing the amount of the polymerization initiator used, reducing the amount of the chain transfer agent used, or using a radical scavenger.

In the post treatment of the emulsion polymerization, the decomposition temperature can be increased by setting the drying temperature to 150° C. or higher.

In suspension polymerization, the endothermic peak temperature can be increased, the standard specific gravity can be lowered, and the melt viscosity can be increased by reducing the amount of the polymerization initiator used and reducing the amount of the chain transfer agent used, preferably not using the chain transfer agent. In the post treatment, the decomposition temperature can be increased by performing washing and setting the drying temperature to 150° C. or higher.

The raw-material composition may be molded by any method, and any known molding method can be employed.

In the case of using a powder obtained by emulsion polymerization, for example, the raw-material composition powder can be mixed with an extrusion aid and then paste extrusion molded. The extrusion aid can be removed by drying. Compression molding of the raw-material composition powder is also preferred. A dispersion of the raw-material composition may be applied to a substrate such as a glass cloth and dried. Sintering may be performed, if needed.

In the case of using a powder obtained by suspension polymerization, for example, a molding method such as compression molding, ram extrusion molding, or isostatic compression molding can be used. Sintering may be performed, if needed.

The PTFE molded article may be processed by machining such as cutting to produce a molded article having a desired shape. For example, a PTFE sheet can be obtained by cutting the PTFE molded article.

The disclosure also provides an insulating member for an electrochemical device, exhibiting non-melt-moldability (hereafter, also referred to as insulating member (2) of the disclosure).

The insulating member (2) of the disclosure exhibiting non-melt-moldability can maintain insulating properties even at high temperatures. Even if the temperature of a cell of an electrochemical device becomes abnormally high (for example, 400° C. or higher), the insulating member (2) of the disclosure can maintain good insulating properties and can prevent short circuits of the cell and short circuits between the components of the cell.

The phrase “exhibits non-melt-moldability” herein means that the melt flow rate (MFR) is lower than 0.10 g/10 min, preferably lower than 0.01 g/10 min.

The MFR is a value obtained in conformity with ASTM D1238 using a melt indexer, as the mass (g/10 min) of a polymer flowing out of a nozzle (inner diameter: 2.095 mm, length: 8 mm) per 10 minutes at 372° C. and a load of 5000 g (total load).

The insulating member (2) of the disclosure may contain a resin exhibiting non-melt-moldability (hereafter, also referred to as a non-melt-moldable resin), a filler, or the like. The non-melt-moldable resin may be a fluororesin or a fluorine-free resin.

The non-melt-moldable resin has almost no fluidity at high temperatures. Accordingly, in order to further improve the insulating properties, the thermal decomposition temperature of the non-melt-moldable resin is preferably 480° C. or higher, more preferably 485° C. or higher, still more preferably 490° C. or higher, further preferably 492° C. or higher, particularly preferably 495° C. or higher. It may be 600° C. or lower, 550° C. or lower, or 520° C. or lower.

The thermal decomposition temperature refers to a temperature at which the mass of the sample is reduced by 1% by mass in an air atmosphere at a temperature-increasing rate of 10° C./min using a simultaneous thermogravimetric analyzer (STA7200 available from Hitachi High-Tech Science Corp.).

The non-melt-moldable resin is also preferably crosslinked.

Examples of the non-melt-moldable resin include PTFE, ultra-high-molecular-weight polyethylene, thermosetting resins, and crosslinked resins. Among these, preferred are PTFE, ultra-high-molecular-weight polyethylene, phenolic resin, epoxy resin, melamine resin, urea resin, unsaturated polyester resin, alkyd resin, silicone resin, polyurethane, thermosetting polyimide, and crosslinked polyethylene, and more preferred are PTFE and ultra-high-molecular-weight polyethylene.

The PTFE may be the same as the PTFE in the insulating member (1) of the disclosure.

The ultra-high-molecular-weight polyethylene preferably has a weight average molecular weight of 1.0×10⁶ or more, more preferably 2.0×10⁶ or more, while preferably 7.0×10⁷ or less, more preferably 7.0×10⁶ or less.

The molecular weight of the ultra-high-molecular-weight polyethylene can be determined by gel permeation chromatography (GPC) in polystyrene equivalent.

Examples of commercially available ultra-high-molecular-weight polyethylene include TIVAR UHMW-PE available from Mitsubishi Chemical Advanced Materials AG and HI-ZEX MILLION available from Mitsui Chemicals, Inc.

The filler is preferably an insulating filler, and is not preferably a conductive filler. Examples of the filler include known insulating fillers such as aluminum oxide, silicon oxide, magnesium oxide, anhydrous magnesium carbonate, magnesium hydroxide, silicon oxide, silicon nitride, boron nitride, and aluminum nitride, with magnesium oxide, aluminum nitride, and boron nitride being preferred.

The insulating member (2) of the disclosure may contain a component other than the non-melt-moldable resin but preferably consists essentially of the non-melt-moldable resin. This allows remarkable exertion of the effect attributable to the non-melt-moldable resin. The phrase “consists essentially of the non-melt-moldable resin” means that the amount of the non-melt-moldable resin is 70% by mass or more based on the insulating member.

The amount of the non-melt-moldable resin is preferably 90.0% by mass or more, more preferably 95.0% by mass or more, still more preferably 99.0% by mass or more, particularly preferably 99.9% by mass or more, most preferably 99.95% by mass or more based on the insulating member.

The insulating member (2) of the disclosure also preferably consists of the non-melt-moldable resin.

The insulating member (2) of the disclosure can be produced by molding a raw-material composition containing a raw-material resin into a desired shape. The raw-material composition may be in any form such as powder or a dispersion, and is preferably in the form of powder. The molding method is not limited, and the molding method exemplified for the insulating member (1) of the disclosure or any known molding method can be employed.

The insulating member of the disclosure is a member used for electrical insulation in an electrochemical device. The insulating member of the disclosure may provide insulation between two or more conductive members in an electrochemical device, for example, between a positive electrode and a negative electrode, or between an electrode and another member (for example, an exterior such as a lid).

In order to further improve the insulating properties at high temperatures, the endothermic peak temperature of the insulating member of the disclosure is preferably 333° C. or higher, more preferably 335° C. or higher, still more preferably 337° C. or higher, further preferably 340° C. or higher, while it is preferably 350° C. or lower, more preferably 346° C. or lower.

The endothermic peak temperature is the temperature corresponding to the minimum point on a heat-of-fusion curve obtained by performing differential scanning calorimetry (DSC) at a temperature-increasing rate of 10° C./min on an insulating member having no history of being heated to a temperature of 300° C. or higher. In the case where one melting peak includes two or more local minimums, each minimum is defined as an endothermic peak temperature.

In order to further improve the insulating properties at high temperatures, the melting point of the insulating member of the disclosure is preferably 315° C. or higher, more preferably 320° C. or higher, still more preferably 323° C. or higher, further preferably 325° C. or higher, while it is preferably 335° C. or lower, more preferably 330° C. or lower.

The melting point is the temperature corresponding to the minimum point on a heat-of-fusion curve obtained by performing differential scanning calorimetry (DSC) at a temperature-increasing rate of 10° C./min on an insulating member having a history of being heated to a temperature of 300° C. or higher.

In order to delay the temperature rise when heat is generated to prevent the temperature from becoming abnormally high in a short period of time, the heat of fusion of the insulating member of the disclosure is preferably 27 J/g or more, more preferably 30 J/g or more, still more preferably 33 J/g or more, further preferably 50 J/g or more, particularly preferably 60 J/g or more, while it may be 90 J/g or less or 80 J/g or less.

The heat of fusion is a value measured using a differential scanning calorimeter (DSC).

In order to further improve the insulating properties at high temperatures, the heat of crystallization of the insulating member of the disclosure is preferably 50 J/g or less, more preferably 40 J/g or less, still more preferably 30 J/g or less, further preferably 25 J/g or less, while it may be 10 J/g or more or 15 J/g or more.

The heat of crystallization is a value measured using a differential scanning calorimeter (DSC).

In order to further improve the insulating properties at high temperatures, the thermal decomposition temperature of the insulating member of the disclosure is preferably 400° C. or higher, more preferably 430° C. or higher, still more preferably 450° C. or higher. It may be 600° C. or lower, 550° C. or lower, or 520° C. or lower.

The thermal decomposition temperature refers to a temperature at which the mass of the sample is reduced by 1% by mass in an air atmosphere at a temperature-increasing rate of 10° C./min using a simultaneous thermogravimetric analyzer (STA7200 available from Hitachi High-Tech Science Corp.).

In order to further improve the insulating properties at high temperatures, the melt viscosity at 380° C. of the insulating member of the disclosure is preferably 1.0×10⁷ Pa·s or more, more preferably 1.0×10⁸ Pa·s or more. It may be 1.0×10¹¹ Pa·s or less or 5.0×10¹⁰ Pa·s or less.

The melt viscosity is determined using a rheometer MCR 302 (available from Anton Paar Japan K.K.). The complex viscosity measured using a parallel plate with a diameter of 7 mm as a measurement jig, at a deformation rate of 0.3%, a sample thickness of 0.5 mm, a temperature of 380° C., and a frequency of 0.01 radians per second was taken as the melt viscosity.

In order to further improve the insulating properties at high temperatures, the standard specific gravity (SSG) of the insulating member of the disclosure is preferably 2.200 or less, more preferably 2.190 or less, still more preferably 2.180 or less, further preferably 2.175 or less, while it may be 2.130 or more, 2.140 or more, or 2.150 or more.

The SSG is determined by the water displacement method in conformity with ASTM D792 using a sample molded in conformity with ASTM D4895-89.

The insulating member of the disclosure preferably has non-melt secondary processibility. The non-melt secondary processibility refers to a property of a polymer with which the melt flow rate is not measurable at a temperature higher than the melting point in conformity with ASTM D1238 and D2116, in other words, a property with which the polymer does not easily flow even within a melting point range.

In order to further improve the insulating properties at high temperatures, the insulation resistance of the insulating member of the disclosure after heating at 450° C. is preferably 1 MΩ or more, more preferably 10 MΩ or more, still more preferably 100 MΩ or more.

The insulation resistance is measured by the method described in the EXAMPLES to be described later.

Having good sealing properties even at high temperatures, the insulating member of the disclosure is also suitably usable as a sealing member. A sealing member is a member used to prevent the leakage of liquid or gas or the intrusion of liquid or gas from the outside. Examples of the sealing member include a gasket and a packing. Of these, preferred is a gasket (insulating gasket).

The insulating member of the disclosure may have any shape such as a ring shape. The insulating member of the disclosure may have a shape such as a circle, an ellipse, or a rectangle with rounded corners in a plan view, and may have a through-hole in the center.

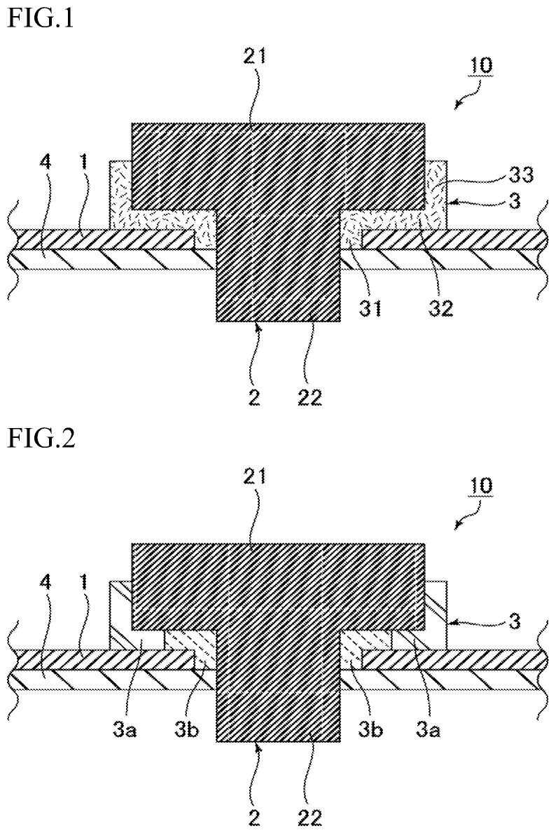

The insulating member of the disclosure may have a cylinder portion and a flange portion that extends radially outward from one end of the opening of the cylinder portion. The insulating member having such a configuration can be suitably used, for example, to insulate an external terminal having a terminal head and a shaft. In this configuration, when the shaft of the external terminal is positioned to face the inner side of the electrochemical device (e.g., when it faces the same direction as the external terminal 2 in FIG. 1 and FIG. 2 described later), the insulating member of the disclosure is preferably arranged such that the end of the opening opposite to the end where the flange portion is present in the cylinder portion faces the inner side of the electrochemical device. When the shaft of the external terminal is positioned to face the outer side of the electrochemical device (e.g., when it is inverted vertically relative to the external terminal 2 in FIG. 1 and FIG. 2), the insulating member of the disclosure is preferably arranged such that the end of the opening opposite to the end where the flange portion is present in the cylinder portion faces the outer side of the electrochemical device.

A usage form of the insulating member according to an embodiment of the disclosure is described with reference to the drawing.

An electrochemical device 10 (such as a sealed type rectangular secondary battery) in FIG. 1 includes an outer can (not illustrated) and a lid 1. An electric element (not illustrated) such as a power generator is housed inside the outer can, and the opening of the outer can is hermetically sealed with the lid 1.

The lid 1 is provided with an external terminal 2 (positive electrode terminal or negative electrode terminal). Externally generated power is supplied to the electric element via the external terminal 2 for storage, and the stored power is supplied to an external load via the external terminal 2.

An insulating member (gasket) 3 and an insulating plate 4 is provided on the lid 1 to electrically insulate the external terminal 2 from the lid 1. The insulating member 3 corresponds to the insulating member of the disclosure.

The external terminal 2 has a terminal head 21 having a rectangular parallelepiped block shape and a columnar shaft 22. The shaft 22 protrudes from the lower surface (on the inner side of the electrochemical device) of the terminal head 21.

As illustrated in FIG. 1, the insulating member 3 has a cylinder portion 31, a flange portion 32 that extends radially outward from one end of the opening of the cylinder portion 31, and a side wall portion 33 that rises from the periphery of the flange portion 32.

The cylinder portion 31 is fitted onto the shaft 22 of the external terminal 2, and the inner circumferential surface of the cylinder portion 31 is in contact with the outer circumferential surface of the shaft 22. The cylinder portion 31 is inserted into the through hole of the lid 1, and the outer circumferential surface of the cylinder portion 31 is in contact with the inner circumferential surface of the through hole of the lid 1.

The flange portion 32 is sandwiched between the lid 1 and the external terminal 2, with one contact surface of the flange portion 32 being in contact with the bottom surface of the external terminal 2 and the other contact surface of the flange portion 32 being in contact with the top surface of the lid 1.

The insulating member 3 comes into contact with the external terminal 2 and the lid 1 with the cylinder portion 31 and the flange portion 32 of the insulating member 3 in a compressed state, thereby ensuring the hermeticity of the electrochemical device.

The insulating member of the disclosure can be used alone, and may be used in combination with another member. The insulating member of the disclosure and another member may be arranged in layers. The another member may be an insulating member or a sealing member.

The another member preferably contains a material different from the insulating member of the disclosure, for example, a fluorine-free resin such as polyethylene (PE), polypropylene (PP), or polybutylene terephthalate (PBT), or a fluororesin other than PTFE such as tetrafluoroethylene/perfluoro (alkyl vinyl ether) copolymer (PFA).

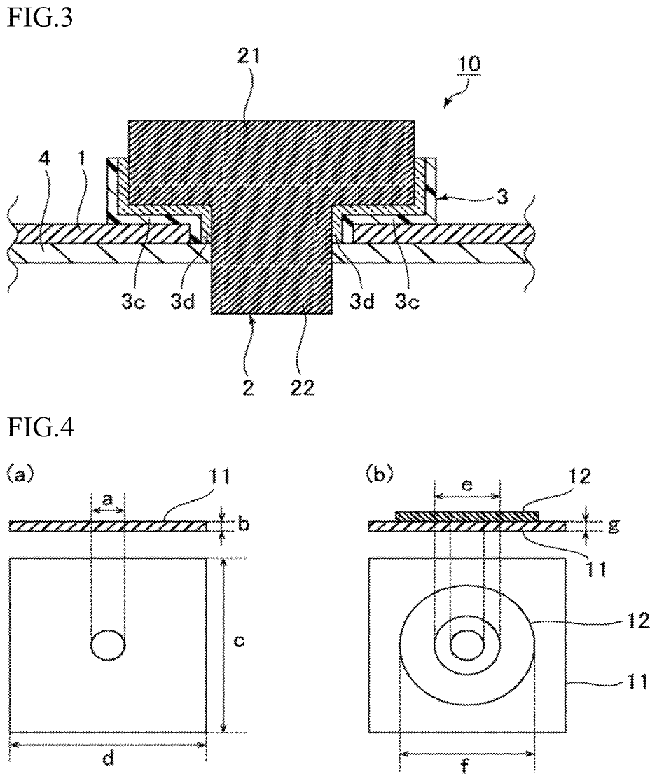

Specific examples of the insulating member of the disclosure used in combination with another member are shown in FIGS. 2 and 3.

In FIG. 2, the insulating member (gasket) 3 includes a member 3a containing PTFE and ensuring insulating properties at high temperatures and a member 3b containing another material (e.g., PP) and ensuring sealing properties under normal conditions not involving high temperatures. The member 3a and the member 3b may be in contact with each other, or they may be adjacent to each other but not in contact with each other. The “adjacent” state refers to a state where the members are not in contact with each other but are within 3 mm of each other. The same effect can be achieved even if the materials and functions of the member 3a and the member 3b are interchanged.

In FIG. 3, the insulating member (gasket) 3 has a laminated structure including a member 3c containing PTFE and ensuring insulating properties at high temperatures and a member 3d containing another material (e.g., PP) and ensuring insulating properties under normal conditions not involving high temperatures.

The member 3c and the member 3d may partially overlap. The partially overlapping state means that when comparing the members 3c and 3d, there is an area where the members 3c and 3d do not overlap due to reasons such as their edges not aligning, their widths or depths being different, the positions being misaligned, or the presence of holes or gaps.

By making the member 3c smaller than the member 3d, the material cost can be reduced. By making the member 3c larger than the member 3d, the insulating properties at high temperatures can be improved. The member 3c may have holes or gaps. In such a case, the material cost can be reduced. With the member having no holes or gaps, the insulating properties at high temperatures can be improved. The member 3c may be divided into multiple parts, which may facilitate assembly.

The following methods can be exemplified as methods for realizing the configuration in which the insulating member of the disclosure and another member are arranged in layers.

(I) A molded article in which the insulating member of the disclosure and another member are preliminarily arranged in layers is produced, and then mounted onto an electrochemical device.

(II) The insulating member of the disclosure and another member, as separate members, are mounted and fixed onto an electrochemical device to be arranged in layers.

(III) A portion of the surface of another member is coated with a material (e.g., PTFE) of the insulating member of the disclosure, and then the resulting member is mounted onto an electrochemical device.

The following methods can be exemplified as specific methods for the coating in the method (III).

(i) A dispersion containing the material of the insulating member of the disclosure (e.g., PTFE dispersion) is applied to the surface of another member. The coating may be then dried, which may be further followed by sintering.

(ii) A sintered tape containing the material of the insulating member of the disclosure (e.g., sintered PTFE tape) is wrapped around the surface of another member.

(iii) A not-fully sintered or unsintered tape containing the material of the insulating member of the disclosure (e.g., not-fully sintered or unsintered PTFE tape) is wrapped around the surface of another member.

(iv) A not-fully sintered or unsintered tape containing the material of the insulating member of the disclosure (e.g., not-fully sintered or unsintered PTFE tape) is attached to the surface of another member. The tape may be attached via an adhesive or glue.

The insulating member of the disclosure is used in electrochemical devices such as batteries and capacitors.

Examples of batteries include secondary batteries such as lithium-ion batteries and sodium-ion batteries.

Sodium-ion secondary batteries are secondary batteries in which sodium ions in an electrolyte solution are responsible for electrical conduction. Examples of the active material of the positive electrode include sodium metal oxides. Examples of the salt in the electrolyte solution include: inorganic sodium salts such as NaPF₆, NaBF₄, NaClO₄, and NaAsF₆; and organic sodium salts such as NaCF₃SO₃, NaPF₃(C₂F₅)₃, NaN(CF₃SO₂)₂, NaN(C₂F₅SO₂)₂, NaC(CF₃SO₂)₃, and NaN(FSO₂)₂. Examples of the material of the negative electrode include hard carbon.

The insulating member of the disclosure may be used in any capacitor. An electrochemical capacitor is preferred. Examples of electrochemical capacitors include electric double layer capacitors, hybrid capacitors, and redox capacitors. Examples of hybrid capacitors include sodium ion capacitors, lithium ion capacitors, and magnesium ion capacitors. Among these, electric double layer capacitors are particularly preferred.

The insulating member of the disclosure can be suitably used as an insulating member for a battery, and can be particularly suitably used as an insulating member for a secondary battery such as a lithium-ion battery or a sodium-ion battery.

The secondary battery may be a secondary battery including an electrolyte solution or may be a solid-state secondary battery.

The solid-state secondary battery herein is a secondary battery containing a solid electrolyte. It may be a semi-solid-state secondary battery containing, as an electrolyte, a solid electrolyte and a liquid component, or an all-solid-state secondary battery containing a solid electrolyte alone as an electrolyte.

The insulating member of the disclosure can be used in a state where it is in contact with an electrolyte included in an electrochemical device, that is, it can have a surface in contact with the electrolyte. Even when used in such a state, the insulating member of the disclosure can maintain insulating properties at high temperatures.

The electrolyte here encompasses not only the electrolyte itself, but also substances derived from the electrolyte, and may be liquid, solid, or gas. The gas encompasses, for example, gas resulting from the volatilization of the electrolyte or gas generated by the decomposition of the electrolyte solution during charging and discharging.

The electrochemical device of the disclosure preferably includes a non-aqueous electrolyte solution. The insulating member of the disclosure can be used in a state where it is in contact with a non-aqueous electrolyte solution included in an electrochemical device, that is, it can have a liquid-contact surface with the non-aqueous electrolyte solution included in the electrochemical device.

The non-aqueous electrolyte solution used may be a solution obtained by dissolving a known electrolyte salt in a known organic solvent for dissolving an electrolyte salt.

Any organic solvents for dissolving electrolyte salts may be used. One or more of known hydrocarbon solvents such as propylene carbonate, ethylene carbonate, butylene carbonate, γ-butyrolactone, 1,2-dimethoxyethane, 1,2-diethoxyethane, dimethyl carbonate, diethyl carbonate, and ethyl methyl carbonate; and fluorine solvents such as fluoroethylene carbonate, fluoroether, and fluorinated carbonate can be used.

Examples of electrolyte salts include LiClO₄, LiAsF₆, LiBF₄, LiPF₆, LiN(SO₂CF₃)₂, LiN(SO₂C₂F₅)₂, LiCl, LiBr, CH₃SO₃Li, CF₃SO₃Li, and cesium carbonate. In order to achieve favorable cycle characteristics, preferred is LiPF₆, LiBF₄, LiN(SO₂CF₃)₂, LiN(SO₂C₂F₅)₂, or a combination of any of these.

The concentration of the electrolyte salt is preferably 0.8 mol/L or higher, more preferably 1.0 mol/L or higher. The upper limit is usually 1.5 mol/L, though it depends on the organic solvent for dissolving an electrolyte salt used.

The solid electrolyte used in a solid-state secondary battery may be a sulfide-based solid electrolyte or an oxide-based solid electrolyte. In particular, when a sulfide-based solid electrolyte is used, the flexibility of the sheet is advantageously improved.

The sulfide-based solid electrolyte is not limited. The sulfide-based solid electrolyte used may be any one selected from Li₂S—P₂S₅, Li₂S—P₂S₃, Li₂S—P₂S₃—P₂S₅, Li₂S—SiS₂, LiI—Li₂S—SiS₂, LiI—Li₂S—P₂S₅, LiI—Li₂S—P₂O₅, LiI—Li₃PO₄—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, Li₄₋ₓGe₁₋ₓPₓS₄ (X=0.6 to 0.8), Li_{4+y}Ge_{1-y}Ga_{y}S₄ (y=0.2 to 0.3), LiPSCl, LiCl, Li_{7-x-2y}PS_{6-x-y}Clₓ (0.8≤x≤1.7, 0<y≤−0.25x+0.5), and Li₁₀SnP₂S₁₂, or a mixture of two or more thereof.

The sulfide-based solid electrolyte preferably contains lithium. Sulfide-based solid electrolytes containing lithium are used in solid-state batteries in which lithium ions are used as carriers, and are particularly preferred in that they provide electrochemical devices having high energy density.

The oxide-based solid electrolyte is preferably a compound that contains an oxygen atom (O), has conductivity of metal ions belonging to Group 1 or Group 2 of the periodic table, and has electronic insulating properties.

Specific examples of the compound include LiₓₐLa_{ya}TiO₃ (xa=0.3 to 0.7, ya=0.3 to 0.7) (LLT), Li_{xb}La_{yb}Zr_{zb}M^{bb}_{mb}O_{nb} (wherein M^{bb} includes at least one element selected from Al, Mg, Ca, Sr, V, Nb, Ta, Ti, Ge, In, and Sn; xb satisfies 5≤xb≤10; yb satisfies 1≤yb≤4; zb satisfies 1≤zb≤4; mb satisfies 0≤mb≤2; and nb satisfies 5≤nb≤20), Li_{xc}B_{yc}M^{cc}_{zc}O_{nc} (wherein M^{cc} includes at least one element selected from C, S, Al, Si, Ga, Ge, In, and Sn; xc satisfies 0≤xc≤5; yc satisfies 0≤yc≤1; zc satisfies 0≤zc≤1; and nc satisfies 0≤nc≤6), Li_{xd}(Al,Ga)_{yd}(Ti, Ge)_{zd}Si_{ad}P_{md}O_{nd} (1≤xd≤3, 0≤yd≤2, 0≤zd≤2, 0≤ad≤2, 1≤md≤7, and 3≤nd≤15), Li₍₃₋₂ₓₑ₎M^{ee}ₓₑD^{ee}O (wherein xe is a number of 0 or greater and 0.1 or smaller, M^{ee} is a divalent metal atom, D^{ee} is a halogen atom or a combination of two or more halogen atoms), Li_{xf}Si_{yf}O_{zf} (1≤xf≤5, 0<yf≤3, and 1≤zf≤10), Li_{xg}S_{yg}O_{zg} (1≤xg≤3, 0<yg≤2, and 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w<1), Li_{3.5}Zn_{0.25}GeO₄ having a lithium super ionic conductor (LISICON) crystal structure, La_{0.51}Li_{0.34}TiO_{2.94} having a perovskite crystal structure, La_{0.55}Li_{0.35}TiO₃, LiTi₂P₃O₁₂ having a natrium super ionic conductor (NASICON) crystal structure, Li_{1+xh+yh}(Al,Ga)ₓₕ(Ti,Ge)₂₋ₓₕSi_{yh}P_{3-yh}O₁₂ (0≤xh≤1 and 0≤yh≤1), and Li₇La₃Zr₂O₁₂ (LLZ) having a garnet crystal structure. Ceramic materials in which element substitution is performed for LLZ are also known. Examples thereof include Li_{6.24}La₃Zr₂Al_{0.24}O_{11.98} and Li_{6.25}Al_{0.25}La₃Zr₂O₁₂ in which partial element substitution using Al is performed for LLZ, Li_{6.6}La₃Zr_{1.6}Ta_{0.4}O₁₂ in which partial element substitution using Ta is performed for LLZ, and Li_{6.75}La₃Zr_{1.75}Nb_{0.25}O₁₂ in which partial element substitution using Nb is performed for LLZ. Other examples include LLZ-based ceramic materials in which element substitution using at least one of magnesium (Mg) and A (A includes at least one element selected from the group consisting of calcium (Ca), strontium (Sr), and barium (Ba)) is performed for LLZ. Phosphorus compounds containing Li, P and O are also desirable. Examples include lithium phosphate (Li₃PO₄), LiPON in which one or more oxygen atoms in lithium phosphate are replaced with nitrogen, and LiPOD¹ (wherein D¹ includes at least one selected from Ti, V, Cr, Mn, Fe, Co, Ni, Cu, Zr, Nb, Mo, Ru, Ag, Ta, W, Pt, Au, and the like). LiA¹ON (wherein A¹ includes at least one selected from Si, B, Ge, Al, C, Ga, and the like) can also be preferably used. Specific examples include Li₂O—Al₂O₃—SiO₂—P₂O₅—TiO₂—GeO₂ and Li₂O—Al₂O₃—SiO₂—P₂O₅—TiO₂.

The oxide-based solid electrolyte preferably contains lithium. Oxide-based solid electrolytes containing lithium are used in solid-state batteries in which lithium ions are used as carriers, and are particularly preferred in that they provide electrochemical devices having high energy density.

The oxide-based solid electrolyte is preferably an oxide having a crystal structure. Oxides having a crystal structure are particularly preferred in terms of good Li ion conductivity. The oxide having a crystal structure may be of perovskite type (e.g., La_{0.51}Li_{0.34}TiO_{2.94}), NASICON type (e.g., Li_{1.3}Al_{0.3}Ti_{1.7}(PO₄)₃), or garnet type (e.g., Li₇La₃Zr₂O₁₂ (LLZ)). Preferred among these is the garnet type.

It should be appreciated that a variety of modifications and changes in the structure and other details may be made to the aforementioned embodiments without departing from the spirit and scope of the claims.

The disclosure (1) relates to an insulating member for an electrochemical device, containing a polytetrafluoroethylene composition containing polytetrafluoroethylene, the polytetrafluoroethylene including a tetrafluoroethylene homopolymer or a modified polytetrafluoroethylene containing a tetrafluoroethylene unit and 1.0% by mass or less of a modifying monomer unit.

The disclosure (2) relates to the insulating member according to the disclosure (1), wherein the polytetrafluoroethylene composition has a heat of crystallization of 50 J/g or less.

The disclosure (3) relates to the insulating member according to the disclosure (1) or (2), wherein the polytetrafluoroethylene composition exhibits non-melt-moldability.

The disclosure (4) relates to the insulating member according to any one of the disclosures (1) to (3), wherein the polytetrafluoroethylene includes the modified polytetrafluoroethylene.

The disclosure (5) relates to the insulating member according to any one of the disclosures (1) to (4), wherein the modifying monomer includes perfluoro (propyl vinyl ether).

The disclosure (6) relates to the insulating member according to any one of the disclosures (1) to (5), wherein the electrochemical device includes a non-aqueous electrolyte solution.

The disclosure (7) relates to the insulating member according to any one of the disclosures (1) to (6), wherein the insulating member is a gasket.

The disclosure (8) relates to the insulating member according to any one of the disclosures (1) to (7), wherein the modified polytetrafluoroethylene contains the modifying monomer unit in an amount of 0.20% by mass or less based on the total polymerized units.

The disclosure (9) relates to the insulating member according to the disclosure (8), wherein the polytetrafluoroethylene is contained in an amount of 99.0% by mass or more based on the polytetrafluoroethylene composition and
the polytetrafluoroethylene composition is contained in an amount of 99.0% by mass or more based on the insulating member.

The disclosure (10) relates to the insulating member according to the disclosure (9), wherein the insulating member has a melt flow rate of less than 0.10 g/10 min.

The disclosure (11) relates to an insulating member for an electrochemical device, exhibiting non-melt-moldability.

The disclosure (12) relates to the insulating member according to the disclosure (11), wherein the insulating member has a melt flow rate of less than 0.10 g/10 min, and
the insulating member contains polytetrafluoroethylene.

The disclosure (13) relates to the insulating member according to any one of the disclosures (1) to (12), wherein the electrochemical device is a lithium-ion battery or a sodium-ion battery.

The disclosure (14) relates to the insulating member according to any one of the disclosures (1) to (13), wherein the insulating member has a heat of fusion of 50 J/g or more.

### EXAMPLES

The disclosure is described in more detail below with reference to examples, but is not limited to these examples.

Physical properties were measured by the following methods.

### <Amount of Modifying Monomer>

A sample was press-molded into a thin-film disc and the thin-film disc was subjected to FT-IR measurement, so that infrared absorbances were obtained. The amount of PPVE contained in PTFE was determined by multiplying the ratio (absorbance at 995 cm⁻¹)/(absorbance at 935 cm⁻¹) by 0.14.

The amount of PPVE contained in PFA was measured using an NMR analyzer (e.g., AVANCE 300 with a high-temperature probe, available from Bruker BioSpin).

### <Standard Specific Gravity (SSG)>

The SSG was determined by the water displacement method in conformity with ASTM D792 using a sample molded in conformity with ASTM D4895-89.

### <Heat of Fusion>

The resulting sheet was cut and about 3 mg thereof was precisely weighed out and placed in a dedicated aluminum pan. Using an X-DSC7000 (available from Hitachi High-Tech Science Corporation), the temperature was raised to 40° C. above the melting peak temperature at a rate of 10° C./min in a nitrogen atmosphere to measure the heat of fusion. The heat of fusion was determined by drawing a line from 40° C. below the melting peak temperature to 20° C. above the melting peak temperature on the obtained DSC chart, and determining the area enclosed by the curve including the peak and the line.

### <Heat of Crystallization>

The resulting sheet was cut and about 3 mg thereof was precisely weighed out and placed in a dedicated aluminum pan. Using an X-DSC7000 (available from Hitachi High-Tech Science Corporation), the temperature was raised to 40° C. above the crystallization peak temperature at a rate of 10° C./min in a nitrogen atmosphere, held at that temperature for one minute, and cooled to 60° C. below the crystallization peak temperature at a rate of 10° C./min to measure the heat of crystallization at the crystallization point. The value of the heat of crystallization was determined by drawing a line from the point at 30° C. below the crystallization peak temperature to the point at 25° C. above the crystallization peak temperature on the obtained DSC chart and calculating the area enclosed by the curve including the peak and the line.

### <Melt Viscosity>

The melt viscosity was determined using a rheometer MCR 302 (available from Anton Paar Japan K.K.). The complex viscosity measured using a parallel plate with a diameter of 7 mm as a measurement jig, at a deformation rate of 0.3%, a sample thickness of 0.5 mm, a temperature of 380° C., and a frequency of 0.01 radians per second was taken as the melt viscosity. If the viscosity is too low or if the polymer of the sample is gasified due to thermal decomposition, the melt viscosity is determined as 100 Pa·s or less.

### <Melt Moldability (MFR)>

In conformity with ASTM D1238 using a melt indexer, the mass (g/10 min) of a polymer flowing out of a nozzle (inner diameter: 2.095 mm, length: 8 mm) per 10 minutes at 372° C. and a load of 5000 g (total load) was measured. Those having an MFR of 0.10 g/10 min or more were judged to be melt-moldable, and those having an MFR of less than 0.10 g/10 min were judged to be not melt-moldable (exhibiting non-melt-moldability). If the fluidity is too low to measure the MFR, the MFR is less than 0.10 g/10 min. If the fluidity is too high or if the polymer of the sample gasifies due to thermal decomposition, the MFR is determined as 100 g/10 min or more.

### <Insulation Resistance>

Using the resulting sheet, as illustrated in FIG. 4(a), a test piece 11 (a=3.5 mm, b=0.2 mm, and c=d=30 mm in FIG. 4(a)) was prepared, which was a square sheet of 30 mm×30 mm×0.2 mm thick with a hole of 3.5 mm in diameter opened in the center thereof.

As illustrated in FIG. 4(b), the test piece 11 and a washer 12 (e=6.5 mm, f=18 mm, and g=1 mm in FIG. 4(b)) were stacked and fixed such that the centers of the holes of the test piece 11 and the washer 12 were aligned.

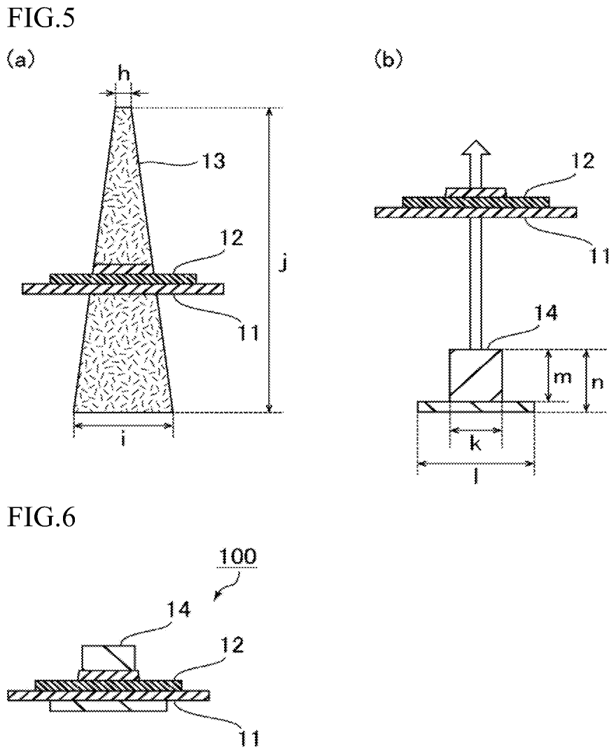

As illustrated in FIG. 5(a), the hole in the test piece 11 was enlarged using a tapered punch 13 (h=1 mm, i=8 mm, and j=40 mm in FIG. 5(a)), and a cylindrical sleeve portion was formed, which had an outer circumferential surface partly in contact with the inner circumferential surface of the hole in the washer 12.

As illustrated in FIG. 5(b), the shaft of a pin 14 (k=6 mm, 1=12 mm, m=6 mm, and n=8 mm in FIG. 5(b)) having a disc-shaped base and a cylindrical shaft was inserted into the sleeve portion, whereby a test assembly 100 shown in FIG. 6 was obtained.

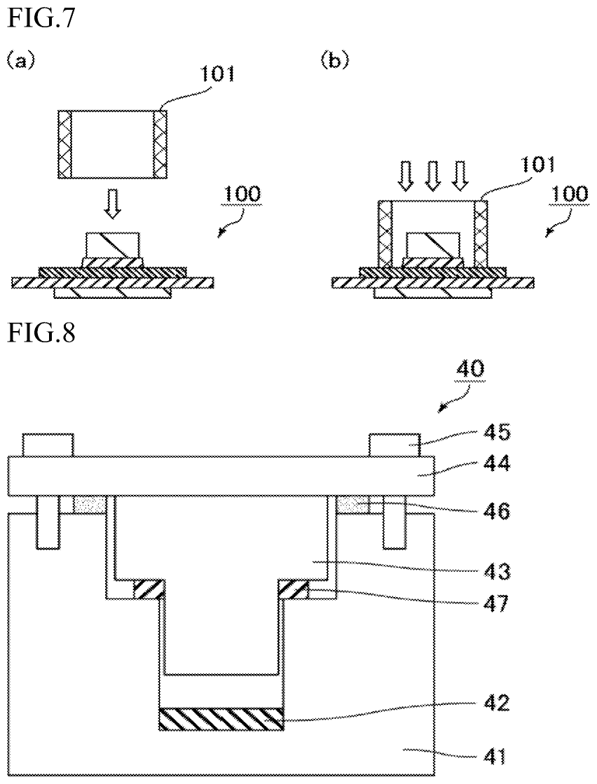

As illustrated in FIG. 7(a), a tubular jig 101 was placed over the washer 12 of the test assembly 100, and the test assembly 100 was placed in an electric furnace with a load of 5 kg being applied via the tubular jig 101 in the direction of the arrows in FIG. 7(b).

The test assembly 100 was heated in the electric furnace to an initial temperature of 250° C., and then the temperature was raised to a holding temperature of 450° C. at a temperature-increasing rate of 10° C./min. The test assembly was heat-treated at the holding temperature for 10 minutes, and then cooled to room temperature. After the cooling, the load was removed and the resistance value between the washer 12 and the pin 14 was measured using an insulation tester (Device name: Digital M-ohm hitester 3454, available from Hioki E.E. Corporation) at an applied voltage of 250 V.

When the insulation resistance was more than 100 MΩ, the insulating properties were judged to be maintained after heating at 450° C. When the insulation resistance was less than 10Ω, the insulating properties were judged to be lost after heating at 450° C.

The insulating properties were also evaluated in the same manner when the holding temperature was set to 350° C. When the insulation resistance was more than 100 MΩ, the insulating properties were judged to be maintained after heating at 350° C. When the insulation resistance was less than 10Ω, the insulating properties were judged to be lost after heating at 350° C.

### <Water Vapor Transmission Test>

As shown in FIG. 8, 2 g of water 42 was placed in an aluminum alloy cup 41. A gasket 47 was placed between the cup 41 and a gasket compression jig 43, and a lid 44 was fastened with a bolt 45 to compress the gasket 47. A spacer 46 was installed between the lid 44 and the cup 41, allowing the compression ratio of the gasket 47 to be adjusted to 37.5% or 58%.

The compression ratio was determined using the following formula.

$$( Compression ratio of gasket ( \% ) ) = \{ 1 - ( Distance of gap ( where gasket is placed ) between cup 41 and gasket compression jig 43 ) / ( height of gasket before compression ) \} \times 100$$

The mass of a transmission test jig 40 thus obtained was measured. The transmission test jig 40 was placed in an electric furnace at 80° C. and left for 1000 hours. The transmission test jig 40 was then taken out and left at room temperature for two hours, followed by measurement of the mass. The water vapor transmission coefficient was determined using the following formula. The above operation was repeated three times to determine the average of the water vapor transmission coefficient. The average values are shown in Table 2.

$$Water vapor transmission coefficient ( g / 1000 hr ) = ( Mass of trasmission test jig before heating ) - ( Mass of trasmission test jig after heating )$$

### Example 1

A PTFE powder (TFE homopolymer obtained by suspension polymerization, SSG=2.159) was compression molded under the conditions of a pressure of 30 MPa and the holding time of five minutes, heated to 365° C. at a rate of 50° C./min in an electric furnace, heat-treated at 365° C. for 5.5 hours, and then cooled to room temperature, whereby a molded article with a diameter of 50 mm was obtained. The resulting molded article was cut to obtain a PTFE sheet A with a thickness of 0.2 mm. The PTFE sheet A exhibited non-melt-moldability.

Using the PTFE sheet A, the physical properties were measured by the above methods. The results are shown in Table 1.

Using the above-obtained molded article with a diameter of 50 mm, a ring-shaped gasket A with a rectangular cross section, an inner diameter of 14.3 mm, an outer diameter of 17.7 mm, and a height of 1.6 mm was obtained. The gasket A exhibited non-melt-processibility.

The water vapor transmission coefficient was measured by the water vapor transmission test using the gasket A. The results are shown in Table 2.

### Example 2

A PTFE powder (TFE homopolymer obtained by emulsion polymerization, SSG=2.172) was mixed with a lubricant (trade name: Isopar G®, available from Exxon Corporation), and the mixture was paste extruded using a sheet-shaped extrusion die. The lubricant was removed by heat treatment at 230° C. for 30 minutes, whereby a PTFE sheet B with a thickness of 0.2 mm was obtained. The PTFE sheet B exhibited non-melt-moldability.

Using the PTFE sheet B, the physical properties were measured by the above methods. The results are shown in Table 1.

Similarly, the PTFE powder was mixed with the lubricant and paste extruded using a die with a RR of 100 as described in ASTM D4895. The lubricant was removed by heat treatment at 30° C. for 30 minutes, whereby a PTFE strand E with a diameter of about 2.5 mm was obtained. The PTFE strand exhibited non-melt-moldability.

The PTFE strand was bent into a gasket shape with an inner diameter of 16 mm and the ends of the strand overlapped by 3 mm, whereby a gasket B was obtained. The gasket B exhibited non-melt-processibility.

The water vapor transmission coefficient was measured by the water vapor transmission test using the gasket B. The results are shown in Table 2.

### Example 3

A PTFE sheet C with a thickness of 0.2 mm was obtained as in Example 1, except that the PTFE powder in Example 1 was replaced by a PTFE powder (PPVE-modified PTFE (TFE/PPVE=99.89/0.11% by mass) obtained by suspension polymerization, SSG=2.175). The PTFE sheet C exhibited non-melt-moldability.

Using the PTFE sheet C, the physical properties were measured by the above methods. The results are shown in Table 1.

### Comparative Example 1

PFA pellets (TFE/PPVE=96.1/3.9% by mass, MFR=15.3 g/10 min) were melted in a hot plate press at 370° C. for 20 minutes, and then water-cooled while being pressurized at a pressure of 1 MPa, whereby a PFA sheet with a thickness of 0.2 mm was obtained. The PFA sheet exhibited melt-moldability.

Using the PFA sheet, the physical properties were measured by the above methods. The results are shown in Table 1.

### Comparative Example 2

A PTFE sheet D with a thickness of 0.2 mm was obtained as in Comparative Example 1, except that the PFA pellets in Comparative Example 1 were replaced by a PTFE powder (TFE homopolymer, MFR=22 g/10 min). The PTFE sheet D exhibited melt-moldability.

Using the PTFE sheet D, the physical properties were measured by the above methods. The results are shown in Table 1.

### Comparative Example 3

A polypropylene (PP) sheet with a thickness of 0.2 mm was obtained as in Comparative Example 1, except that the PFA pellets in Comparative Example 1 were replaced by PP (trade name: Prime Polypro F227, available from Prime Polymer Co., Ltd.) and the temperature of the hot plate press was changed from 370° C. to 280° C.

Using the PP sheet, the physical properties were measured by the above methods. The results are shown in Table 1.

Similarly, PP was heated to a temperature equal to or higher than the melting point and a sheet was formed. Using the sheet, a ring-shaped gasket C with a rectangular cross section, an inner diameter of 14.3 mm, an outer diameter of 17.7 mm, and a height of 1.6 mm was obtained.

The water vapor transmission coefficient was measured by the water vapor transmission test using the gasket C. The results are shown in Table 2.

### Comparative Example 4

A polybutylene terephthalate (PBT) sheet with a thickness of 0.2 mm was obtained as in Comparative Example 1, except that the PFA pellets in Comparative Example 1 were replaced by PBT (trade name: PBT Natural color, unfilled, available from Kureha Extron Co., Ltd.) and the temperature of the hot plate press was changed from 370° C. to 280° C.

Using the PBT sheet, the physical properties were measured by the above methods. The results are shown in Table 1.

Similarly, PBT was heated to a temperature equal to or higher than the melting point and a sheet was formed. Using the sheet, a ring-shaped gasket D with a rectangular cross section, an inner diameter of 14.3 mm, an outer diameter of 17.7 mm, and a height of 1.6 mm was obtained.

The water vapor transmission coefficient was measured by the water vapor transmission test using the gasket D. The results are shown in Table 2.

TABLE 1

| | | | | | | | | Insulating | Insulating |
|---|---|---|---|---|---|---|---|---|---|
| | | | Heat | | | | | properties | properties |
| | | Heat of | of | | | Melt | Insulation | after | after |
| | | crystallization | fusion | Modifying | MFR | viscosity | resistance | heating | heating |
| | Test piece | (J/g) | (J/g) | monomer | (g/10 min) | (Pa · s) | (Ω) | at 450° C. | at 350° C. |
| Example 1 | PTFE sheet A | 25 | 30 | Not used | Not measurable | 3.2 × 10⁸ | >100M | Maintained | Maintained |
| Example 2 | PTFE sheet B | 35 | 75 | Not used | Not measurable | 3.0 × 10⁸ | >100M | Maintained | Maintained |
| Example 3 | PTFE sheet C | 25 | 22 | PPVE | Not measurable | 2.3 × 10⁸ | >100M | Maintained | Maintained |
| Comparative | PFA sheet | 27 | 25 | PPVE | 15.3 | 790 | <10 | Lost | Lost |
| Example 1 | | | | | | | | | |
| Comparative | PTFE sheet D | 80 | 65 | Not used | 22 | 340 | <10 | Lost | Lost |
| Example 2 | | | | | | | | | |
| Comparative | PP sheet | 76 | 85 | — | ≥100 | ≤100 | <10 | Lost | Lost |
| Example 3 | | | | | | | | | |
| Comparative | PBT sheet | 54 | 67 | — | ≥100 | ≤100 | <10 | Lost | Lost |
| Example 4 | | | | | | | | | |

TABLE 2

| | | Water vapor |
|---|---|---|
| | | transmission |
| | Compression ratio | coefficient |
| | (%) | (g/1000 hr) |
| Example 1 | 37.5 | 0.012 |
| Example 2 | 58 | 0.001 |
| Comparative | 37.5 | 0.005 |
| Example 3 | | |
| Comparative | 37.5 | 0.007 |
| Example 4 | | |

The PTFE sheets (PTFE compositions) produced in the examples were suitably usable as insulating members for electrochemical devices.

### REFERENCE SIGNS LIST

10: electrochemical device
1: lid
2: external terminal
21: terminal head
22: shaft
3: insulating member (gasket)
31: cylinder portion
32: flange portion
33: side wall portion
4: insulating plate
11: test piece
12: washer
13: tapered punch
14: pin
100: test assembly
101: tubular jig
40: transmission test jig
41: cup
42: water
43: gasket compression jig
44: lid
45: bolt
46: spacer
47: gasket

1. An insulating member for an electrochemical device, comprising a polytetrafluoroethylene composition containing polytetrafluoroethylene,
the polytetrafluoroethylene including a tetrafluoroethylene homopolymer or a modified polytetrafluoroethylene containing a tetrafluoroethylene unit and 1.0% by mass or less of a modifying monomer unit.

2. The insulating member according to claim 1,
wherein the polytetrafluoroethylene composition has a heat of crystallization of 50 J/g or less.

3. The insulating member according to claim 1,
wherein the polytetrafluoroethylene composition exhibits non-melt-moldability.

4. The insulating member according to claim 1,
wherein the polytetrafluoroethylene includes the modified polytetrafluoroethylene.

5. The insulating member according to claim 1,
wherein the modifying monomer includes perfluoro (propyl vinyl ether).

6. The insulating member according to claim 1,
wherein the electrochemical device includes a non-aqueous electrolyte solution.

7. The insulating member according to claim 1,
wherein the insulating member is a gasket.

8. The insulating member according to claim 1,
wherein the modified polytetrafluoroethylene contains the modifying monomer unit in an amount of 0.20% by mass or less based on the total polymerized units.

9. The insulating member according to claim 8,
wherein the polytetrafluoroethylene is contained in an amount of 99.0% by mass or more based on the polytetrafluoroethylene composition and
the polytetrafluoroethylene composition is contained in an amount of 99.0% by mass or more based on the insulating member.

10. The insulating member according to claim 9,
wherein the insulating member has a melt flow rate of less than 0.10 g/10 min.

11. The insulating member according to claim 1,
wherein the electrochemical device is a lithium-ion battery or a sodium-ion battery.

12. The insulating member according to claim 1,
wherein the insulating member has a heat of fusion of 50 J/g or more.
